(19) United States
(12) Patent Application Publication
(10) Pub. No.: US 2003/0236041 A1
(43) Pub. Date: Dec. 25, 2003

(54) Fire retardant laminated sheet and manufacturing method thereof

(76) Inventor: Kyun-Kil Lee, Nam-Gu (KR)

Correspondence Address: CANTOR COLBURN, LLP, 55 GRIFFIN ROAD SOUTH, BLOOMFIELD, CT, 06002

(21) Appl. No.: 10/178,376

(22) Filed: Jun. 24, 2002

(51) Int. Cl. B32B 27/04; B32B 13/06; B32B 27/12; B32B 5/02

(52) U.S. Cl. 442/17; 442/131

(57) ABSTRACT

Disclosed are a fire retardant laminated sheet and a manufacturing method thereof. The laminated sheet for various interior applications exhibits improved fire retardancy, so it does not burn in a fire. Such a fire retardant laminated sheet is manufactured by impregnating a fire retardant material with an impregnant containing phenolic resin, to have 25 to 35% resin impregnated by weight, obtaining a sheet base. Then, a melamine resin impregnated paper is stacked on one or both faces of the sheet base thus obtained, and the resultant stacked paper is molded under heat and pressure, using a press, at 130 to 140° C. for 15 to 30 min under a pressure of 50 to 60 kgf/cm².

### BACKGROUND OF THE INVENTION

1. Field of the Invention

The present invention relates to a fire retardant laminated sheet and a manufacturing method thereof, and more particularly to a fire retardant laminated sheet serving as a material for interior and exterior decoration in various buildings, for use in marine furniture, or interior panels exhibiting an improved fire retardancy, thus it does not burn in a fire, while being aesthetically pleasing, and a manufacturing method thereof.

2. Description of the Related Art

As well known to those skilled in the art, laminated sheets have been used as a material for indoor and outdoor decoration and interior use in various buildings, including tables, counter tops, furniture, and sinks. They have also been employed as decorative laminates for use in furniture, or as interior panels.

Generally, such laminated sheets have been manufactured by performing the following steps. A decorative paper is impregnated with an impregnant containing melamine resin, followed by drying, obtaining a melamine resin impregnated paper. Separately, a layer of kraft paper is impregnated with an impregnant containing phenolic resin, followed by drying, obtaining a phenolic resin impregnated paper. Multiple layers of the phenolic resin impregnated paper are stacked, and the melamine resin impregnated paper is then stacked on any one face or both faces of the above paper-stacked body. Finally, the resultant stacked paper is subjected to molding under a certain temperature and pressure.

As a part of the method described above, Korea Pat. Application No.10-1996-035074, which was previously applied by the present inventors, discloses a manufacturing method of a decorative laminate. According to the reference, a material is impregnated with resin, followed by drying, and the dried material is cut to certain dimensions. 2 to 3 layers of the material thus cut are stacked, and a natural veneer is then stacked on one or both faces thereof. They are finally applied with heat and pressure of 130±10° C. and 50±10 kg/cm², thereby manufacturing a decorative laminate.

Other manufacturing methods for laminated sheets, which are used as a variety of interior decorating materials, interior and exterior finishing materials, and materials for use in furniture, are known. Those laminated sheets have the merit of attractive appearance, being attributable to a layer of natural veneer or decorative paper.

However, such decorative laminates or various laminated sheets for interior use, manufactured according to conventional methods, including the method described above, have a disadvantage of easily burning, due to their poor fire retardancy. Thus, they have a problem of catching fire and contributing to the spread of the fire in case of fire.

### SUMMARY OF THE INVENTION

In view of the above problems, the present inventors have studied to develop a laminated sheet with improved fire retardancy, serving as a decorative laminate or as a material for interior use, which does not burn, while being aesthetically pleasing. Further, the inventors found that in addition to its fire retardancy, the laminated sheet of the invention offers a functionality of far infrared ray emission, being helpful for maintaining a pleasant environment and enhancing human health.

Thus, it is an object of the present invention to provide a fire retardant laminated sheet with improved fire retardancy, serving as a material for various interior uses including decorative laminates, which does not burn, while being aesthetically pleasing.

It is a further object of the present invention to provide a fire retardant laminated sheet additionally having a functionality of far infrared ray emission, thereby being helpful for maintaining a pleasant environment and enhancing human health.

It is another object of the present invention to provide a method for manufacturing the fire retardant laminated sheet in a more efficient manner.

It is yet another object of the present invention to provide a method of utilizing the fire retardant laminated sheet.

In accordance with one aspect of the present invention, the above and other objects can be accomplished by the provision of a manufacturing method of a laminated sheet comprising the steps of impregnating a decorative paper with an impregnant containing melamine resin to have 55 to 65% resin impregnated by weight, followed by drying, stacking the melamine resin impregnated paper on one or both faces of a sheet base, and molding the resultant stacked paper under heat and pressure.

Preferably, the sheet base is obtained by impregnating a fire retarding material with an impregnant containing phenolic resin, to have 25 to 35% resin impregnated by weight. Further, the melamine resin impregnated paper may be stacked on one or both faces of the sheet base, and molded at 130 to 140° C. for 15 to 30 min by applying a pressure of 50 to 60 kgf/cm².

It is preferable that the impregnant containing phenolic resin comprises a far infrared emitting material at 10 to 25% by weight.

In accordance with another aspect of the present invention, there is provided a laminated sheet manufactured by the above method.

In accordance with yet another aspect of the present invention, there is provided a noncombustible material in which a gypsum board or noncombustible metal material is fabricated on a lower surface of the fire retardant laminated sheet manufactured by the above method.

Hereinafter, the invention is described in detail.

To manufacture a fire retardant laminated sheet of the invention, a decorative paper is first impregnated with an impregnant containing melamine resin, so that the resin is contained at an amount of 55 to 65% by weight, followed by drying, thereby obtaining a melamine resin impregnated paper.

The impregnant containing melamine resin used herein may include impregnants commonly used in the art, including the impregnants disclosed in Korea Pat. Appln No.10-1999-45889 and No.10-1999-45890, which are previously applied by the inventors. According to the invention, the melamine resin impregnated paper may be obtained in an easy manner, using a common method in the art, by impregnating a decorative paper with the impregnant containing melamine resin, followed by drying.

The melamine resin impregnated paper thus obtained is stacked on one or both faces of a sheet base, and molded using a press. According to the invention, the sheet base is obtained by impregnating a fire retardant material with an impregnant containing phenolic resin, to have 25 to 35% resin impregnated by weight.

As for the fire retardant material, diverse materials known in the art including a tabular form of glass cloth-reinforcement may be used. The sheet base may be stacked in a single or multiple layers.

As for the impregnant containing phenolic resin for impregnating the fire retardant material, impregnants commonly used in the art may be used. Preferably, the impregnant containing phenolic resin comprises tetrabromobisphenol A at an amount of 5 to 10%, for the purpose of enhancing fire retardancy of the laminated sheet.

That is, after the common impregnant is added with tetrabromobisphenol A at an amount of 5 to 10%, the fire retardant material is impregnated with the above impregnant, obtaining the sheet base. With such a sheet base, the laminated sheet of the invention exhibiting enhanced fire retardancy may be manufactured.

At this time, if the content of tetrabromobisphenol A is less than 5 weight %, insufficient fire retardancy is obtained. On the other hand, if the content is over 10 weight %, tetrabromobisphenol A is poorly dispersed in the impregnant, thereby making it difficult to prepare the impregnant of the invention. Moreover, such high content of tetrabromobisphenol A causes a problem of poor impregnation. Accordingly, it is preferable that tetrabromobisphenol A in the impregnant containing phenolic resin is comprised at an amount within the range described above.

According to the invention, it is preferable that the impregnant containing phenolic resin comprises a far infrared ray emitting material at 10 to 25% by weight, for the purpose of conferring a functionality of far infrared ray emission to the laminated sheet of the invention, in addition to its fire retardancy. That is, a fire retardant material is impregnated with the impregnant containing phenolic resin comprising 10 to 25 weight % of far infrared ray emitting material, to have 25 to 35 weight % resin impregnated. After drying, the sheet base is used for the manufacture of the laminated sheet of the invention.

Since the sheet base thus obtained comprises a large quantity of far infrared ray emitting material, emitting a large quantity of far infrared rays, the laminated sheet of the invention is helpful for maintaining a pleasant environment and enhancing human health. The far infrared ray emitting material may include diverse far infrared ray emitting materials known in the art, such as powders of 200 to 300 mesh of charcoal, ocher and quartz porphyry.

At this time, if the content of far infrared ray emitting material is less than 10 weight %, insufficient far infrared ray emission is obtained. On the other hand, if the content is over 25 weight %, the far infrared ray emitting material is precipitated, thereby making it difficult to prepare the impregnant of the invention. Accordingly, it is more preferable that the impregnant containing phenolic resin comprises the far infrared ray emitting material at an amount of 10 to 25 weight %.

In the invention, the melamine resin impregnated paper is stacked on its one or both faces of the sheet base thus obtained, and molded under heat and pressure.

Such molding under heat and pressure is performed at a temperature of 130 to 140° C. for 15 to 30 min, under a pressure of 50 to 60 kgf/cm². If the pressure for molding is applied at less than 130° C. and for less than 15 min, resin is not sufficiently cured, thereby decreasing a bonding force. On the other hand, if pressure application is performed at over 140° C. and for more than 30 min, the melamine resin impregnated paper is exposed to the high temperature for a long time, thereby causing deformation of the paper. Moreover, if the pressure is applied at less than 50 kgf/cm², the bonding force between the sheet base and the melamine resin impregnated paper is decreased due to insufficient pressure, thereby causing delamination. On the other hand, if the pressure is applied at over 60 kgf/cm², the melamine resin impregnated paper may burst. Accordingly, it is preferable that molding under heat and pressure is performed within the range of conditions described above.

Where molding under heat and pressure is performed within the ranges as described above, the fire retardant laminated sheet of the invention can be obtained. The laminated sheet thus obtained does not burn in a fire due to its content of fire retardant material. In addition, the laminated sheet employs a decorative paper as an exterior finishing material, which is impregnated with the impregnant containing melamine resin, thereby being aesthetically pleasing.

Further, the laminated sheet of the invention is helpful for maintaining a pleasant environment and enhancing human health, since the sheet comprises a large quantity of far infrared ray emitting material, emitting a large quantity of far infrared rays.

Thus, the laminated sheets manufactured according to the invention can be used as a material for interior and exterior decoration and interior use in various buildings, for use in marine furniture, or interior finishing. In addition, other various applications are possible.

According to the invention, the laminated sheet manufactured by the above method may be added with a gypsum board or noncombustible metal material, fabricated on a lower surface thereof. More specifically, where the fire retardant laminated sheet is added with a gypsum board in diverse ways, a fire retardant gypsum board panel with more superior fire retardancy may be obtained. Also, where the fire retardant laminated sheet is added with noncombustible metal material selected from the group consisting of aluminum, stainless steel and iron sheet, in diverse ways, a fire retardant metal panel with more superior fire retardancy may be obtained.

In such a way, when the fire retardant laminated sheet is added with a gypsum board or noncombustible metal material, offering more superior fire retardancy, a fire retardant product with considerably improved fire retardant effect may be obtained.

The invention is further illustrated by the following examples which are not intended to limit the scope of the invention.

### DESCRIPTION OF THE PREFERRED EMBODIMENTS

### Preparation 1

Impregnant Containing Melamine Resin

With respect to 100 weight parts of a solution of melamine and formalin at a 1:1.8 molar ratio, 3 weight parts of PVA, 15 weight parts of water, 10 weight parts of methyl alcohol, 0.2 weight parts of a surfactant, 1.0 weight part of a curing agent, and 0.3 weight parts of silicon oil were mixed, preparing an impregnant containing melamine resin.

### Preparation 2-1

Impregnant Containing Phenolic Resin

With respect to 100 weight parts of a solution of phenol and formalin at a 1:0.94 molar ratio, 2.4 weight parts of an aqueous ammonia solution and 50 weight parts of methanol were mixed, preparing an impregnant containing phenolic resin.

### Preparation 2-2

Impregnant Containing Phenolic Resin

To the impregnant containing phenolic resin prepared as in Preparation 2-1, 10 weight parts of tetrabromobisphenol A was further added, followed by mixing, preparing an impregnant containing phenolic resin.

### Preparation 2-3

Impregnant Containing Phenolic Resin

To the impregnant containing phenolic resin prepared as in Preparation 2-1, 20 weight parts of powdered charcoal with 300 mesh was further added, followed by mixing, preparing an impregnant containing phenolic resin.

### EXAMPLE 1

With the impregnant containing melamine resin prepared as in Preparation 1, a layer of decorative paper was impregnated to have 58% resin impregnated by weight, followed by drying at 120° C., thus obtaining a layer of melamine resin impregnated paper. Separately, with the impregnant containing phenolic resin prepared as in Preparation 2-1, a tabular form of glass cloth was impregnated to have 30% resin impregnated by weight, followed by drying at 140° C., thus obtaining a layer of sheet base. Then one layer of the melamine resin impregnated paper was stacked on the sheet base. The stacked paper was molded using a press which was heated to 132° C., for 25 min under a pressure of 58 kgf/cm². After molding, a hot plate of the press was water-cooled to room temperature, followed by dismounting, obtaining a laminated sheet. The laminated sheet thus manufactured was tested according to the processes described below, in terms of bond strength, abrasion strength and fire retardancy. The results are shown in Table 1.

A. Bond Strength

The laminated sheet manufactured above was subjected to a direct thermal application of 200° C. on its surface, and then the time until delamination occurred between the glass cloth and the impregnated paper was measured.

B. Abrasion Strength

The test was performed in accordance with the process specified in Korean Industrial standards KS M 3332 referring to an abrasion resistance test for decorative laminates impregnated with thermosetting resin.

C. Fire Retardancy

The test was performed in accordance with the process specified in Korean Industrial standards KS F 2271 referring to a fire retardancy test for interior finishing materials of buildings and for structures.

### EXAMPLE 2

A laminated sheet was manufactured according to the same method as Example 1, except for employing a layer of sheet base obtained by impregnating a tabular form of glass cloth with the impregnant containing phenolic resin prepared as in Preparation 2-2, to have 30% resin impregnated by weight, followed by drying at 140° C. The laminated sheet thus manufactured was tested in terms of bond strength, abrasion strength and fire retardancy according to the same processes as Example 1. The results are shown in Table 1.

### EXAMPLE 3

A laminated sheet was manufactured according to the same method as Example 1, except for employing a layer of sheet base obtained by impregnating a tabular form of glass cloth with the impregnant containing phenolic resin prepared as in Preparation 2-3, to have 30% resin impregnated by weight, followed by drying at 140° C. The laminated sheet thus manufactured was tested in terms of bond strength, abrasion strength and fire retardancy according to the same processes as Example 1. The results are shown in Table 1.

### EXAMPLE 4

On the lower surface of the laminated sheet manufactured as in Example 1 was fabricated a gypsum layer with a thickness of 12.5 cm, manufacturing a noncombustible gypsum board panel. The gypsum board panel was tested in terms of bond strength, abrasion strength and fire retardancy according to the same processes as Example 1. The results are shown in Table 1.

### COMPARATIVE EXAMPLE 1

With the impregnant containing melamine resin prepared as in Preparation 1, a layer of decorative paper was impregnated to have 58% resin impregnated by weight, followed by drying at 120° C., thus obtaining a layer of melamine resin impregnated paper. Separately, with the impregnant containing phenolic resin prepared as in Preparation 2-1, a layer of kraft paper was impregnated to have 40% resin impregnated by weight, followed by drying at 110° C., thus obtaining a layer of phenolic resin impregnated paper. Then one layer of the melamine resin impregnated paper was stacked on phenolic resin impregnated paper. The stacked paper were molded using a press which was heated to 120° C., for 25 min under a pressure of 45 kgf/cm². After molding, a hot plate of the press was water-cooled to room temperature, followed by dismounting, manufacturing a laminated sheet. The laminated sheet thus manufactured was tested in terms of bond strength, abrasion strength and fire retardancy, according to the same processes as Example 1. The results are shown in Table 1.

### Test Example 1

The laminated sheet manufactured as in Example 3 was processed to form specimens with dimensions of 4 mm×4 mm×3 mm. The specimens were subjected to measurements of infrared spectral reflectivity and radiation energy using a FT-IR spectrometer(5˜20 μm, at 40° C.) The results are shown in Table 1.

TABLE 1

| | Bond | Abrasion | | Far infrared radiation | |
|---|---|---|---|---|---|
| | strength | strength | | | Radiation |
| | (time in | (abrasion | Fire | Spectral | energy |
| | sec.) | frequency) | retardancy | reflectivity | (w/m²) |
| Ex. 1 | 70 | 400 | Class 2 | — | — |
| Ex. 2 | 60 | 400 | Class 2 | — | — |
| Ex. 3 | 60 | 400 | Class 2 | 88 | 3.16 × 10² |
| Ex. 4 | 70 | 400 | Class 1 | — | — |
| Comp. | 27 | 200 | lower than | — | — |
| Ex. 1 | | | Class 3 | | |

As shown in Table 1, the laminated sheets manufactured as in Examples 1 to 4 exhibited considerably improved fire retardancy, compared to Comparative Example 1.

Especially, as for the laminated sheet manufactured as in Example 3, a benefit of far infrared ray emission is additionally obtained, together with its fire retardancy, since it comprises powdered charcoal as a far infrared radiating material. Therefore, upon application as a material for interior decoration in various buildings, such far infrared ray emission is helpful for maintaining a pleasant environment and enhancing human health.

In addition, the gypsum board panel of Example 4, which was manufactured by fabricating a gypsum layer on the lower surface of the laminated sheet manufactured as in Example 1, received a Class 1 rating of fire retardancy. Accordingly, such a noncombustible gypsum board panel exhibited improved fire retardancy, compared to the laminated sheet manufactured as in Example 1.

Taken together, the noncombustible laminated sheet manufactured according to the invention can reduce fire hazards, since it does not burn in a fire, compared to conventional laminated sheets.

As apparent from the above description, the present invention provides a fire retardant laminated sheet for interior applications in various buildings. The laminated sheet exhibiting improved fire retardancy does not burn, while being aesthetically pleasing. Further, in addition to its fire retardancy, the laminated sheet of the invention offers a functionality of far infrared ray emission, being helpful for maintaining a pleasant environment and enhancing human health.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A manufacturing method of a fire retardant laminated sheet comprising the steps of:
impregnating a decorative paper with an impregnant containing melamine resin to have 55 to 65% resin impregnated by weight, followed by drying;
stacking the melamine resin impregnated paper on one or both faces of a sheet base, the sheet base being obtained by impregnating a fire retardant material with an impregnant containing phenolic resin, to have 25 to 35% resin impregnated by weight; and
molding the resultant stacked paper under heat and pressure, using a press, at 130 to 140° C. for 15 to 30 min under a pressure of 50 to 60 kgf/cm².

2. The manufacturing method as set forth in claim 1, wherein the impregnant containing phenolic resin comprises a far infrared ray emitting material at 10 to 25% by weight.

3. The manufacturing method as set forth in claim 2, wherein the far infrared ray emitting material is selected from the group consisting of powders of 200 to 300 mesh of charcoal, ocher and quartz porphyry.

4. The manufacturing method as set forth in claim 2, wherein the fire retardant material is a tabular form of glass cloth.

5. The manufacturing method as set forth in claim 4, wherein the impregnant containing phenolic resin further comprises tetrabromobisphenol A at an amount of 5 to 10% by weight.

6. A fire retardant laminated sheet manufactured by the manufacturing method as set forth in claim 1.

7. A fire retardant gypsum board panel obtained by adding a gypsum board onto a lower surface of the fire retardant laminated sheet manufactured by the manufacturing method as set forth in claim 1.

8. A fire retardant metal panel material obtained by adding a noncombustible metal material selected from the group consisting of aluminum, stainless steel and iron sheet, onto a lower surface of the fire retardant laminated sheet manufactured by the manufacturing method as set forth in claim 1.
